(19) United States
(12) Patent Application Publication
(10) Pub. No.: US 2003/0069668 A1
(43) Pub. Date: Apr. 10, 2003

(54) Modular, robotic road repair machine

(76) Inventor: William Harrison Zurn, Sunnyvale, CA (US)

Correspondence Address: William H. Zurn, 602 San Conrado Terr. #1, Sunnyvale, CA, 94085, US

(21) Appl. No.: 09/972,347

(22) Filed: Oct. 9, 2001

(51) Int. Cl. G06F 19/00

(52) U.S. Cl. 700/245

(57) ABSTRACT

The invention relates to a combination asphalt/concrete surface repair machine. The machine is a direction-finding, wheeled, transportable vehicle, which is a self-regulating, repair contraption, controlled by a complex central computer. The machine is capable of being attached to and hauled by another faster vehicle (i.e., truck) if necessary.

This machine is guided by a positioning device, which uses advanced radar and laser technology to place the machine above each position of the road surface to be repaired. It uses seismic or radar analyzer technology to determine road surface repair requirements.

The machine uses data from the seismic or radar analyzer to repair the road surface by the use of robotic modules within the machine. This technology can also be used to build new roads, racetracks, airport runways, sidewalks, driveways, parking lots, etc.

My invention is a very complex machine and provides multifaceted construction or repair functions within one machine.

REFERENCES CITED

U.S. PATENT DOCUMENTS

BACKGROUND OF THE INVENTION

BRIEF SUMMARY OF THE INVENTION

Phase I

Phase II

Phase m

BRIEF DESCRIPTION OF THE FIGURES.

Fig A, Highway with Markers

Fig B, Analysis Phase Two

Fig C, Side View of the Machine

Fig D, Top View of the Machine

Fig E, The Machine Performing Repair Operations

DETAILED DESCRIPTION OF THE INVENTION

The Machine's Central Computer

Road Surface Analyzer

Modular Design of Road Repair Robotic Units

Asphalt Hopper

Repair Material Conveyor

Asphalt and Cement Filling Modules

Digging Robotic Module

Drilling/Jackhammer

Grinder Module

Sawing Module

Robotic Rolling Module

Crack & Joint Sealing Module

CLAIMS OF THE PATENT

ABSTRACT OF THE DISCLOSURE

SUMMARY

### REFERENCES CITED

U.S. PATENT DOCUMENTS

In this section I have reviewed U.S. patents, displayed the most technical or advanced techniques with respect to road surface repair patents and compared these patents to my patent. The differences between my patent and those patents compared to will be italicized. U.S. Pat. No. 5,721,685 Holland, Feb. 24, 1998 Digi-track digital roadway and railway analyzer A horizontal position and vertical elevation measurement apparatus and method for measuring horizontal positioning and absolute elevations of railways, paved or unpaved roadways, and other travel surfaces. The apparatus is capable of determining longitudinal and transverse elevation profiles in an X-Y-Z coordinate format usable with Geographical Information Systems (GIS) and Land Information Systems (LIS) to project present and future traffic counts and traffic flow patterns. It can measure the horizontal location and elevations of paved and unpaved travel surfaces, potholes, cracks, wheel ruts, etc. within a travel surface, and the horizontal location and elevations of railway tracks when conventional railroad high rail gear is used. The apparatus has Global Positioning System (GPS) signal-receiving units fixed to each end of a sensor bar mounted on a vehicle perpendicular to vehicle movement. Depending upon the type of surface is being located; the sensor bar has a combination of non-mechanical sonic or infrared distance sensors placed across the sensor bar between the GPS signal-receiving units, which gather vertical elevation information. Concurrent with collection of information from the GPS units and the distance sensors, a video camera projects downward at the travel surface and provides a visual reference of the surface conditions should collected data exceed preset ranges. Measurement intervals are user defined. Raw digital data is stored in an onboard computer system. The data is later transferred to a remote computer for post processing, analysis and generation of the final formatted electronic file by proprietary and copyrighted software. Inventors: Holland; Robert E. (2021 Art Museum Dr. #140, Jacksonville, Fla. 32207); Brown; Terry S. (1216 Cedar Tree La., Tampa, Fla. 33584); Flowers, Jr.; Roy T. (5035 Nola Ct., Jacksonville, Fla. 32210). Appl. No.: 496,541 Filed: Jun. 29, 1995 While my invention may use similar technology within the radar/seismic module located in the lower slot of my machine, my invention includes much greater capability with respect to the complete repair of the road surface. The patent above only deals with the capability of determining longitudinal and transverse elevation profiles in an X-Y-Z coordinate, whereas my invention encompasses the total needs of repairing the road surface. My invention will analyze the road surface for defects, saw around the defects, dig out to cavity, fill in the cavity with asphalt or concrete, roll the asphalt and provide analysis of the quality of the repair. My invention is different because of the total needs of the road repair being accomplished by one machine. U.S. Pat. No. 5,556,226 Hohmann, Jr. Sep. 17, 1996 Automated, laser aligned leveling apparatus The laser alignment system of apparatus for leveling flowable material, in which two radiant energy beam detectors mounted on opposite ends of an elongated leveling member are responsive to a projected radiant energy beam establishing a leveling plane, is modified for operation when one of the detectors is blocked from receiving the projected radiant energy bean by an obstruction such as a support column, equipment or personnel. Whereas each detector signal is normally used to generate a separate adjustment signal for an adjustment device such as an hydraulic cylinder to raise or lower the associated end of the elongated leveling member, when one detector is blocked from receiving the radiant energy beam the detector elevation signal generated by the other, unblocked, detector is used to generate the adjustment signals for both ends of the elongated leveling member. Inventors: Hohmann, Jr.; Howard E. (Saxonburg, Pa.). Assignee: Garceveur Corporation (Louisville, Ky.). Appl. No.: 391,200 Filed: Feb. 21, 1995 The invention above involves only an alignment system of apparatus for levelingflowable material; my machine will have an asphalt hopper/asphalt delivery system to the asphalt-filling module to apply the proper rate of material required tofill cavities. My machine will have the capability of determining the “treatment swiftness”, or the correct amount of material needed tofill each cavity, which is usually measured as the weight of dry material used per unit area covered. Again, my machine will analyze the road surface for defects, saw around the defects, dig out the cavity, fill in the cavity with asphalt or concrete, roll the asphalt and provide analysis of the quality of the repair. My invention is different because of the total needs of the road repair being finished by one machine, notjust one function (alignment system) covered by the patent above. William Harrision Zurn Page 6 U.S. Pat. No. 5,549,412 Malone, Aug. 27, 1996 Position referencing, measuring and paving method and apparatus for a profiler and paver A profiler is used to collect data on a base surface. An asphalt paver is provided with a like profiler that measures smoothness of a fresh mat of asphalt laid by the paver. The profilers measure surface elevation as a function of forward travel position. The profiler and paver position are determined by a fixed referencing system, such as the Global Positioning System (GPS). Surface elevation is plotted against position of the profiler and used to control a screed leveling a mat of paving material. A subsequent plot shows smoothness of the mat. Inventors: Malone; Kerry (Charleston, Ill.). Assignee: Blaw-Knox Construction Equipment Corporation (Matton, Ill.). Appl. No.: 449,075 Filed: May24, 1995 Intl. Cl. :EOIC 19/22Current U.S. Cl.: 404/84.1; 404/84.2 Field of Search: 404/84.05, 84.1, 84.2, 84.5, 118 The patent above only addresses the profiler that measures smoothness of a fresh mat of asphalt laid by the paver and measures surface elevation as afunction offorward travel position. My invention will inclide robotic modules that provide a similar type offunction. My invention is different because of the total needs of the road repair being completed by one machine, not just the profiler that measures smoothness and measures surface elevation. U.S. Pat. No. 5,752,783 Malone, May 19, 1998 Paver with radar screed control A paving apparatus is provided with a micropower impulse radar device connected to control a leveler. The leveler is a screed provided with actuators for adjusting screed elevation, slope, and extension. The radar senses a reference, such as a string line, and operates the actuators to adjust the screed. Inventors: Malone; Kerry (Charleston, Ill.). Assignee: Blaw-Knox Construction Equipment Corporation (Mattoon, Ill.). Appl. No.: 603,831 Filed: Feb. 20, 1996 The patent above only has the capability to provide a micropower impulse radar device connected to control a leveler. My machine will have the ability to use the asphalt/cement filling modules in conjunction with the radar/seismic module. My machine will be able to determine the characteristics of the craters to be filled, distinguish cavity measurements, and packing levels. My invention is different because of the total needs of the road repair being completed by one machine, notjust the function of the micropower impulse radar device connected to control a leveler. U.S. Pat. No. 5,362,176 Sovik, Nov. 8, 1994 Road construction apparatus and methods Discloses methods and apparatus for use with road construction equipment and apparatus (such as, for example, pavers, road millers and cutters, graders, and the like) including sensing apparatus for sensing and determining a selected edge of an existing pavement structure and controlling the road construction equipment or apparatus (or an element of such equipment or apparatus) in a desired manner with respect to such selected edge. Inventors: Sovik; Robert A. (Clifton Park, N.Y.). Assignee: AW-2R, Inc. (Clifton Park, N.Y.). Appl. No.: 3,003 Filed: Jan. 11, 1993 The invention above covers only the function of the methods and apparatus for use of sensing apparatus for sensing and determining a selected edge of an existing pavement. A part of the process detailed in my patent describes the procedure of surveying the road surface, airport runway, parking lot, bridge, or area to be repaired. During this process the survey team will place reflective markers to be used by the machine during the analysis phase (II) and repair phase (III). These reflective markers will be placed to allow optimum control &placement of the machine over the surfaces repaired during phases' two and three. The reflective markers will provide reference positions to allow the robotic modules to be precisely placed over the areas to be repaired. his process will determine the areas to be repaired and control the movement of the machine regarding the analysis and repair phases of the road repair. My invention is much more elaborate, complex and provides many multifacetedfunctions within one machine. William Harrision Zum Page 9 U.S. Pat. No. 5,294,210 Lemelson, Mar. 15, 1994 Automated pothole sensing and filling apparatus Automated system for pothole repair including apparatus mounted upon a vehicle for detecting the presence of a pothole and alerting and/or slowing and/or halting the vehicle responsive to such detection. Sensors measure the size of the pothole and/or monitor the filling of the pothole to automatically terminate the filling operation when completed. The sensor outputs are used to determine either level of repair material or volume thereof. The sensors and dispenser (or dispensers) are automatically moved to the desired locations. The filled cavity may be compacted and/or cured. Filler material may be selectively delivered from one or more than one dispensing nozzle. Inventors: Lemelson; Jerome (868 Tyner Way, Call Box 14-286, Incline Village, Nev. 89450). Appl. No.: 901,265 Filed: Jun. 19, 1992 This invention only provides aprocess to detect andfill potholes. My invention does this with the asphalt/concrete filling modules. My invention encompasses the total needs of the road repair process, from analysis of the defects in the road surface to the complete repair of the road surface. William Harrision Zurn Page 10 U.S. Pat. No. 4,216,838 Degraeve, Aug. 12, 1980 Compacting apparatus for road surfacing material Apparatus for compacting or consolidating a strip of road surfacing material essentially comprises a selfpropelled compacting machine and a guide vehicle. The guide vehicle has a steerable wheel and a set of drive wheels. The compacting machine is guided for orbital movement around the guide vehicle at a preset turning radius. The guide vehicle may be self-propelled in which case it carries its own motor for driving its driving shaft. Preferably the guide vehicle is driven for progressive displacement along the strip of surfacing material in response to the turning of a coupling bar, connecting the compacting machine with the guide vehicle about its end for determining the turning radius of the former. The coupling bar in turn rotatably drives the driving shaft of the guide vehicle, which in turn drives the drive wheels of the guide vehicle through a power transmission. The guide vehicle is provided with a steering mechanism controlled by a steering control system including a lateral position sensing device disposed on the compacting machine which is connected through an electrically control circuit to operate an electromagnet, for example, for changing the position of the steering mechanism from one limit position to an opposed limit position once the compacting machine gets too close to an edge or the strip being compacted. Inventors: Degraeve; Francois R. (Pont Ste-Maxence, FR); Divay; Rene G (Nogent-sur-Oise, FR); Lecoeur; Jean-Pierre E. (Liancourt, FR). Appl. No.: 864,792 Filed: Dec. 27, 1977 This invention only provides for compacting or consolidating a strip of road surfacing material My invention has a module will be able to determine the characteristics of the craters to befilled, distinguish cavity measurements, and packing levels. My invention will also provide a combination of concrete and asphalt, the machine will be equipped with both a concrete filling module and an asphalt filling module, will be able to provide complete road surface repair. My invention will be able to pack and roll the asphalt in Ihe cavities to be filled. My invention may use similar technology to the invention described above in my asphalt-filling module. My invention is much more complex andprovides many multifacetedfunctions within one machine. William Harrision Zum Page 11 U.S. Pat. No. 4,700,223 Shoutaro, Oct. 13, 1987 Vehicle for evaluating properties of road surfaces The invention provides a vehicle for evaluating the properties of road surfaces wherein a road surface cross-section profile evaluating means, a crack-evaluating means, and a road surface longitudinal profile evaluating means are mounted on a predetermined vehicle. The measuring intervals of the respective means can be controlled in accordance with a signal from a single speedometer/range finder. Three kinds of road surface property values which are matched with each other can be obtained. Even if the evaluation system (evaluation vehicle) and the object system (road surface) have a relative speed, the road surface property values can be accurately determined irrespective of the relative speed. Therefore, accurate and reliable evaluation data can be obtained, and the vehicle can cope with high speed and heavy traffic. Inventors: Shoutaro; Kato (Tokyo, JP); Tatsuhide; Nakane (Tokyo, JP); Tetsuo; Ogiwara (Tokyo, JP). Assignee: Kokusai Kogyo Co., Ltd. (Tokyo, JP). Appl. No.: 832,126 Filed: Feb.24, 1986 The invention above only makes available a technique of evaluating the road surface, my invention has a module, which provides a similar process and may use similar technology. My invention provides this capability, plus much more, meeting the needs of the complete road surface repair. William Harrision Zum Page 12 U.S. Pat. No. 4,899,296 Khattak, Feb. 6, 1990 Pavement distress survey system A pavement inspection apparatus is described for inspecting the condition of a full lane of pavement using a vehicle capable of traveling along the lane at normal traffic speeds, such as 55 miles per hour. The apparatus is capable of determining the size and shapes of surface distress features such as longitudinal cracks, transverse cracks, alligator cracks, design joints, and potholes. The apparatus has two video array cameras that project downward onto the pavement with overlapping fields of view for generating X-Y pixel data from at least a 12-foot lane width of highway pavement as the vehicle moves over the pavement. The cameras are mounted at acute angles with respect to each other. The apparatus includes distress feature analysis electronics for determining the size, shape and location of surface distress features and evaluates such features against preset standard values to determine the severity of the determined features. Additionally, the apparatus has infrared cameras for subsurface exploration. Subsurface pavement features, such as, the soil type and moisture content distribution is determined by the distortions in the surface temperature profile captured by the infrared cameras. Khattak: Anwar S. (612 S. Lincoln, Spokane, Wash. 99204). Appl. No. 229,655 Filed: Aug. 8, 1988 This invention only provides the capability for inspecting the condition of afull lane ofpavement; my invention will have similar technology in the radar/seismic analysis module. Again, my machine is differentiated because of the entire needs of the road repair being done by one machine, not just the function of the micropower impulse radar device connected to control a leveler. William Harrision Zurn Page 13 U.S. Pat. No. 5,075,772 Gebel, Dec. 24, 1991 Method and an apparatus for the surveying of road properties as to the length of the axis, the width and the height or the ascent A method and apparatus for the surveying of road length, road width and height, and ascent and incline of the road, wherein approximately equally spaced measuring marks are applied onto the road surface along the axis of the road, which measuring marks are then approached by a surveyor vehicle and the actual straight line distance between the measuring marks is exactly measured by a gauging system provided on the surveyor vehicle. The measuring marks are scanned by video cameras measurably adjustable on X, Y tables or are scanned by electromagnetic sensors while the position of the video cameras or sensors on the surveyor, which can exactly be measured. For height measurements, a vertical reference line is defined by means of perpendicular bars and laser devices and the distance thereof relative to the road surface is measured at locations, the positions of which can exactly be defined by the video cameras. The measured data are stored digitally and/or as monitor images, on magnetic tapes. Inventors: Gebel; Hans-Peter (Frankfurt, Del.). Assignee: Ingenieurburo Dr. 1 ng. H.-P Gebel (Frankfurt, Del.). Appl. No.: 512,814 Filed: Apr. 23, 1990 The invention above only provides a method of surveying of road length, road width and height, and ascent and incline of the road. The process I have statedfor my invention includes; survey the road surface, airport runway, parking lot, bridge, or area to be repaired. Part of the process stated in my invention indicates the survey team will place reflective markers to be used by the machine during the analysis phase (II) and repair phase aIJI). These reflective markers will be placed to allow optimum control & placement of the machine over the surfaces repaired during phases' two and three. The reflective markers will provide reference positions to allow the robotic modules to be precisely placed over the areas to be repaired My invention will use a similar process of surveying the road surface, but my invention provides a total solution to the road repair. William Harrision Zum Page 14 U.S. Pat. No. 5,323,647 Blanco, Jun. 28, 1994 Apparatus and method for measuring height variations in a surface Apparatus and method for measuring height variations along a directional axis in a roadway surface from a vehicle includes a first sensor for sensing a first distance from the first sensor to a first point on the surface and generating a first signal indicative of the first distance; a second sensor for sensing a second distance from the second sensor to a second point axially separated from the first point on the surface and generating a second signal indicative of the second distance; and a computer for receiving the first and second signals and generating and recording a difference signal indicative of the difference in height of the first and second points, The first and second sensors are operated simultaneously to compensate for vertical motion of the sensors with respect to the surface. Inventors: Blanco; Rudy (Norman, Okla.). Assignee: Pave Tech Inc. (Norman, Okla.) Appl. No.: 626 Filed: Jan. 5, 1993 This invention only deals with an apparatus and methodfor measuring height variations along a directional axis in a roadway surface. My invention will include a process of surveyng the road surface, airport runway, parking lot bridge, or area to be repaired. During this process the survey team will place reflective markers to be used by the machine during the road surface analysis phase and the final phase of repairing the road surface. These reflective markers will be placed to allow optimum control & placement of the machine over the surfaces repaired during phases' two and three. The reflective markers will provide reference positions to allow the robotic modules to be precisely placed over the areas to be repaired. My invention is much more intricate, complex andprovides many multifacetedfunctions within one machine. William Harrision Zurn Page 15 U.S. Pat. No. 5,333,969 Blaha, Aug. 2, 1994 Automated pavement repair vehicle An automated pavement repair vehicle includes a vehicle and its various computer-controlled subsystems. The various subsystems, including a vacuum system, heating system and spray patch system, for completing pavement repair, are located on the frame and rear of the truck. A robotic cell at the rear of the truck includes an assembly of retractable doors. The doors are lowered around the pothole to allow control of ambient conditions during the pavement repair procedure. Inventors. Blaha; James R. (928 Wesley Ave., Evanston, Ill. 60202); Underwood; Herbert N. (5322 N.

McVicker Ave., Chicago, Ill. 60638); Salle; Ralph (24072 N. Lakeside Dr., Lake Zurich, Ill. 60047); Ralston; Ronald R. (620 Adele, Elmhurst, Ill. 60126). Appl. No.: 34,506 Filed: Mar. 19, 1993 3hile this invention does have sub-sections for various repair needs, it is not as complex as my invention regarding sawing into the road surface, analysis of the defects in the road surface, a complex system of delivering asphalt or concrete to the filling modules, rolling the asphalt and then analyzing the cavityfilled with respect to quality of repair. My machine is a much more complex instrument than this invention. William Harrision Zurn Page 17 U.S. Pat. No. 4,557,626 McKay, Dec. 10, 1985 Road patching vehicle A roadway surface-patching vehicle is described wherein virtually all roadway-patching procedures may be performed by a single operator within a control station of the vehicle unit. The vehicle includes a number roadway repair tools mounted to a moveable carriage on the vehicle frame. This carriage is situated intermediate the control station and the front vehicle wheels. Among the operative tools are a cutter head and a vacuum head adjacent to the cutter head for receiving and directing loose particulate roadway surface material to a storage hopper for subsequent reblending and reuse. The vacuum head may also be used to clean the area adjacent the repair following placement and finished tamping and rolling of the new repair materials. A tamping head is also mounted to the carriage for movement therewith and a roller is mounted to the frame for finishing the repair to grade. A spread flame torch is provided on the carriage to heat the prepared cavity, melt ice, or dry the area in the vicinity of the cavity to facilitate reception of the roadway repair material therein. A tack coat spray nozzle is also situated to spray the cavity walls prior to reception of the repair material. All tools may be mounted to a turret on the carriage to be selectively rotated into view prior to operation. All operations involved in preparing the cavity and affecting the repair may thus be performed within full view of the operator station and by a single operator. Inventors: McKay; Jack E. (Hayden Lake, Id.); Brown; Robert E. (Hayden Lake, Id.). Assignee: Road Renovators, Inc. (Hayden Lake, Id.) Appl. No.: 607,923 Filed: May 7, 1984 My machine provides a greater number offunctions as compared to this invention, my invention includes the technology required to analyze the roadway, airport runway, parking lot surface, etc., to be repaired for defects, faults, flaws, etc. My invention includes: sawing modules, drilling modules, asphalt/concrete filling modules, grinding modules to provide for the total needs of the road surface repair project. A major difference is the modular design of the repair robotic units; each module will be of the same size (approximately 4feet by 6feet by 4feet), which permits the placement of any repair module into any slot of the lower level of the machine. Another factor is the capability of the central computer to recognize the location relationship of each module in the machine regardless of which slot in the lower level the module resides. This aspect gives the machine flexibility regarding altering the placement of the repair modules in the machine based on the changes required because of different road surface repair requirements. the modules will utilize technology that is already available, but must be re-engineered tofit into the standard sized module slot in the lower level of the machine. William Harrision Zum Page 18

### BACKGROUND OF THE INVENTION

Road surface defects, including cracks, potholes, sub-surface imperfections and other road nuisances, linked with road surface deficiencies, are experienced very frequently on highways, bridges and other paved surfaces such as airport runways or parking lots, especially where there is an extreme traffic pattern over the surfaces.

The center of attention regarding pavement engineering has changed from design and construction of new highways to preventive maintenance/treatment of the existing highways. A highway maintenance project is typically established on a visual condition survey. Regrettably, by the time indicators of corrosion are visible, major treatment is commonly necessary. If the inception of deterioration can be detected, the problem can often be resolved through preventive maintenance.

The traditional system for renovating these road surfaces necessitates a considerable quantity of labor-intensive activity to repair these surfaces. Even with this effort, the benefits of these repairs are sometimes short lived; the potholes, cracks, etc., appear again within a short period of time.

In addition to the problems of the road surface, motorists' spend billions of dollars each year for front-end alignments, shock absorbers, tire balancing, tires, etc. Furthermore, the traditional means of repairing roads is overwhelming with respect to the amount of time the customary traffic patterns are interrupted.

My invention includes a sophisticated array of robotic modules to detect the types of problems in a roadway, repair these problems, as well as measure the amount of materials needed to make these repairs.

It is therefore a primary object of this invention to provide a machine that will drastically improve the quality of road repairs. The invention also provides significant enhancement over the traditional methods, at significant savings in labor costs.

The invention also provides a method that can easily be adapted to use with various types of highways to diminish the influence of the repairs on the traffic flow and enhance the health and safety of the traveling public. A major advantage of this invention is the fact that one individual can operate the machine, with this one person controlling all aspects of the machine during the repair of the road surface.

The machine will repair roads much faster, less expensively, with superior quality than the traditional methods used today, provide additional safety, and with very little disruption of traffic flows.

The apparent savings to be accomplished by use of the machine are remarkable. The federal and state highway agencies can resolve imminent problems with preventive maintenance at a fraction of the cost of established maintenance or treatment methods.

The machine can recognize precisely which layers and sections necessitate repairs, avoiding costly speculation. The machine will help the maintenance engineers to differentiate between more straightforwardly maintainable road segments and those that actually require more extensive treatment.

### BRIEF SUMMARY OF THE INVENTION

The invention consists of a combination asphalt/concrete surface repair machine controlled by a predominant, centralized computer, and guided by a positioning device which uses advanced radar, laser technology to position the machine on the roadbed. As improvements in positioning apparatus and radar, laser and seismic analyzer technology become available, they may be incorporated into later models/modules of this invention

The invention incorporates three phases or processes:

Phase I

Survey the road surface, airport runway, parking lot, bridge, or area to be repaired. During this process the survey team will place reflective markers to be used by the machine during the analysis phase (II) and repair phase (m). These reflective markers will be placed to allow optimum control & placement of the machine over the surfaces repaired during phases' two and three. The reflective markers will provide reference positions to allow the robotic modules to be precisely placed over the areas to be repaired.

Phase II

The analysis phase consists of using the latest radar, or seismic analyzer technology (each one of these technologies could be placed in a separate module depending on the technology or need) to collect data with respect to the defects (3 dimensional view) in the road surface, airport runway, parking lot, or area to be repaired.

During this phase, the machine will determine the longitudinal and transverse elevation contour of the road surface to be repaired in an X-Y-Z equivalent format This format will be in accord with technology such as: Geographical Information Systems (GIS) or Land Information Systems (LIS).

The purpose of the phase (II) is to profile the requirements of the distinctive repair undertaking. The modular design of the robotic sub-system allows this. Determined by the varying necessities, the radar/seismic detection module can be used in this second phase, removed and then placed in a slot in the lower level of the machine to be used in the next phase (III).

Clarifying this point, a less expense vehicle, with only the modular radar/seismic unit inside it, can be used during phase two to save costs. One objective of the radar/seismic detection phase of the repair is to completely evaluate the characteristics of surface and subsurface situation data collected, this will allow enhanced analysis compared to the long-established methods of visual assessment.

The radar/seismic module is needed during phase two with respect to determining the characteristics of the repair work required.

The data collected from this analysis phase is stored in a database to be used during the repair phase (III). Additionally, the area to be repaired is subdivided into very small dimensions, i.e., one square inch horizontally, plus, up to three feet vertically (depending upon the technology available).

This process will allow the machine used during the repair phase to accurately repair the surface to a very fine detail. Analysis of the road surface will consist of discovering many types of defects, including: cracks, indented regions, protrusions, potholes, etc.

The module containing the latest radar, seismic analyzer technology used during phase two, which collects the data, is constructed such (modularized) that it can be removed from the vehicle used in phase two and be placed in the repair machine used in phase three.

Phase III

Between phase II and phase III, the data stored during analysis phase (II), is reviewed by the decision makers, e.g., civil engineers, material scientists, etc., as to how severe the road surface defect's are. They will then analyze and diagram the proposed solution. The decision-makers will map out, that is, diagram the regions in need of repair. This diagram (computer program) will be used to instruct or guide the central computer (repair machine CPU) used during the repair phase (III), as to how to repair the surface containing defects. The decision makers will determine: how deep to extract the openings, how wide to saw, what material to use, etc., with respect to every section of the surface needing repair.

This invention, the machine being used in the reconstruction and maintenance of the road surface, will contain modularized, computerized, robotics instruments that will be capable of the following:

Grinding

Grooving

Leveling

Sawing into defective segments

Jack hammering to break surface material

Compression hammer to compact material (asphalt)

Drilling and into the defective segment

Filling the cavities with asphalt & concrete

Rolling the asphalt material

In addition, the machine will be able to remove concrete or asphalt from the defective segments by use of a backhoe type device and vacuum system.

Also the machine will be able to place reinforcing rods (cut to required length's by the associated module) and/or reinforcing screens into the segment to be repaired. This invention will be able to fill the defective segments with concrete or asphalt. The machine will be able to repair bumps & waves by scarifying & recompacting surfaces. Holes & depressions that occur in the existing surface will also be corrected before resurfacing or prior to the placing of a leveling course. The machine will repair spalled, scaled & map-cracked surfaces. The machine will have a bump-cutter robotics module for work requiring that purpose. The machine will be able to place crackseal material, petromat fabric or place double chip seal over the entire area under repair

One central computer will control all of these activities; the actions of the machine will be performed based on information collected during phase II. The central computer will execute the program, based on inputs from the decision makers (repair surface area mapped out), to schedule the work among the various modules, prioritize the processes, and turn over control to the modules to finish the tasks assigned. For example, with respect to a section of road ½ mile long, the machine may be assigned over 50 different tasks; the central computer will determine the most efficient schedule algorithms to complete the tasks in the most efficient timeframe.

For example, the machine may have three modules working independently on three different jobs, such as, one module is sawing, one module is drilling, and one of the modules is filling a segment with asphalt. In this case, this is only possible if the machine is in a location such that each module's robotics arm can reach the task site they are assigned to. Otherwise, the central computer controlling the machine must schedule one task and then move the machine to the next location.

Each of the functions described above will be built by means of obtainable, existing hardware and will be customized into individual, self-contained, standard sized, easily removable, easily serviceable modules. Each of these modules will be of exactly the same dimensions. This allows the interchange of the modules into different slots of the lower level of the instrument to permit the machine to flexibly meet various road surface repair requirements.

The module removed from the vehicle used in phase two can (if the customer chooses) be removed from the analysis vehicle and placed in the repair machine (during phase III) to be used to determine if the individual road segments have been adequately repaired. A very important aspect of this invention is the ability to place different types of modules in the machine for repairing road surfaces requiring different types of modules or different types of asphalt and concrete blends.

Regardless of the location of a specific repair module, the central computer will know the modules location in the lower level, if the module is removed and place in a different slot; the central computer will be knowledgeable of this. A standard size module space will allow modules to be moved to any slot in the lower section of the machine. The size of machines will vary regarding the number of slots for modules, some large-scale machines will contain slots for 14 modules, and small versions will contain only 6 modules. With more complex repair projects, that is, a project needing concrete repair, asphalt, replacing steel rods, etc., large machines with more modules will be required.

Additionally, all of the robotic modules described above will be located on the lower level of the machine, the upper level will contain the hoppers needed to hold the concrete, asphalt mix, liquid storage tanks, etc. Also a hopper can be used to collect debris removed during the repair.

Between the upper level (hoppers, storage tanks) and the lower level modular housing structures (sawing devices, compression hammers, etc.), there will be a conduit type area that will contain CPU busses to the modules, air lines, power lines, etc. This section will also contain the transport mechanism to move the asphalt/concrete to the filling modules. The hoppers will also be modular, to allow different configurations based on customers' needs.

The front of the machine will contain the power (engine power and to power the all of the robotic repair modules) unit, and the rear of the machine will contain the central computer.

The dimensions of some types of the repair machine will be such that no special permits are required; that is, it can be transported on any public highway, street, etc. Larger machines may need special permits to transport them on the highways. The machine is capable of being attached to and towed by another faster vehicle (i.e., truck) if necessary, when being transported between road repair projects. The machine is a course-plotting, wheeled, portable vehicle, which is a self-determining, repair mechanism, controlled by a central computer.

The machine is capable of moving & positioning itself, without the need for external power. The machine not only positions itself, but also analytically adjusts the positioning of each of the separate robotic modules over the areas to be repaired. This feature permits the machine to perform more than one function at a time, possibly three or more functions at once, depending on the proximity of the robotic arms and the area to be repaired. The multi-task computer determines whether this is achievable or not. The machine has hoppers, in which the asphalt/cement is loaded periodically as required. The device uses advanced radar, seismic technology to analyze the road surface with respect to the defects in need of repair. This analysis includes irregularities, bumps, cracks, voids, and cavities.

### BRIEF DESCRIPTION OF THE FIGURES

Fig A, Highway with Markers

During phase one a survey team will survey the road surface, airport runway, parking lot, bridge, or area to be repaired. During this process the survey team will place reflective markers (1) to be used by the machine to guide and position itself during the analysis phase two and repair phase three. The reflective makers are placed on the highway boundaries (2). These reflective markers will be placed to allow optimum control & placement of the machine over the surfaces analyzed/repaired during phases' two and three. The reflective markers will provide reference positions to allow the robotic modules to be precisely placed over the areas to be repaired.

Fig B, Analysis Phase Two

During phase two, a small vehicle (4), is using the radar/seismic detection system module (5), positioned over a pothole (3) to analyze and record the defects in the road surface to be repaired. The size, depth, location, etc. of the defect will be stored in the modules' computer. This information will be used later during phase three for the actual repair of the pothole. The radar/seismic detection system module (5) can also be placed in a slot in the larger vehicle and used to analyze the road surface during and after repair of the surface. The wheels of the small vehicle are (12).

Fig C, Side View of the Machine

This figure shows the side view of the machine (11), with it's various hoppers (8 & 10), tank (9) used to store material used during the repair. This figure also shows repair modules (14, 15, 6, 11, 13, 19) used during the repair of the road surface. Also shown is the machine engine (7) and central computer (21). The wheels for the machine are indicated (12).

Fig D, Top View of the Machine

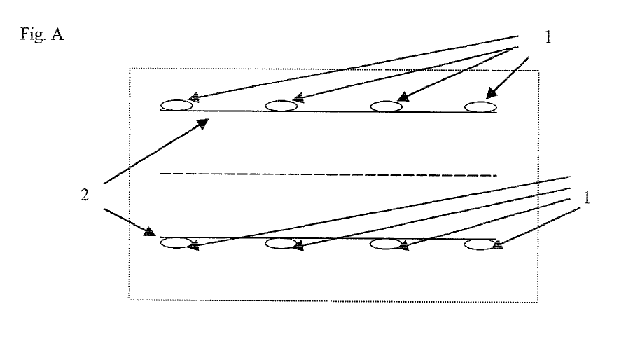

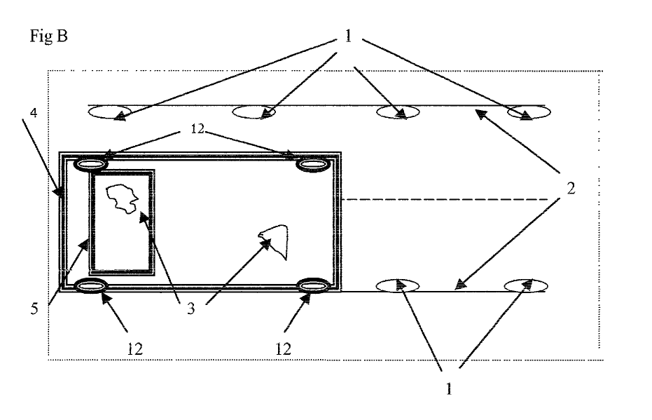

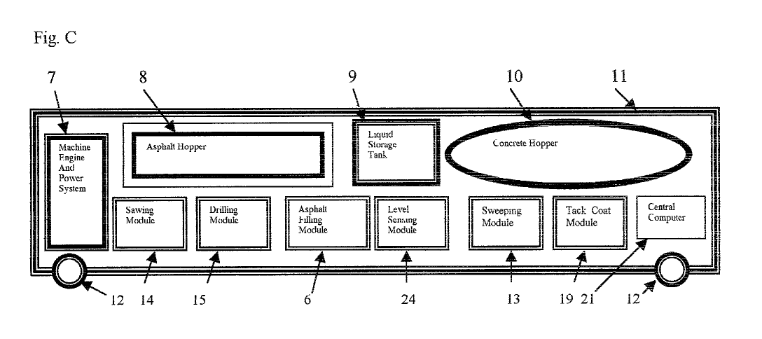

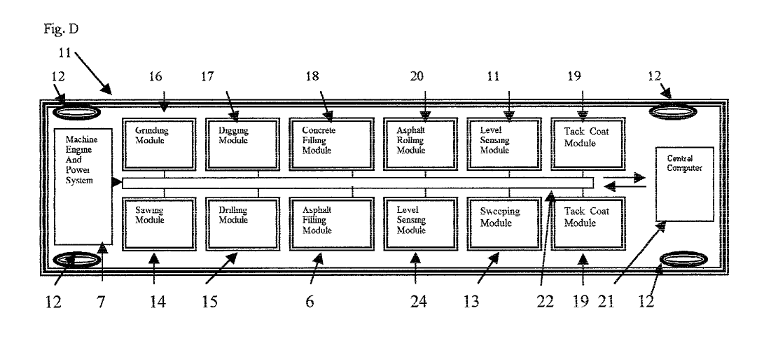

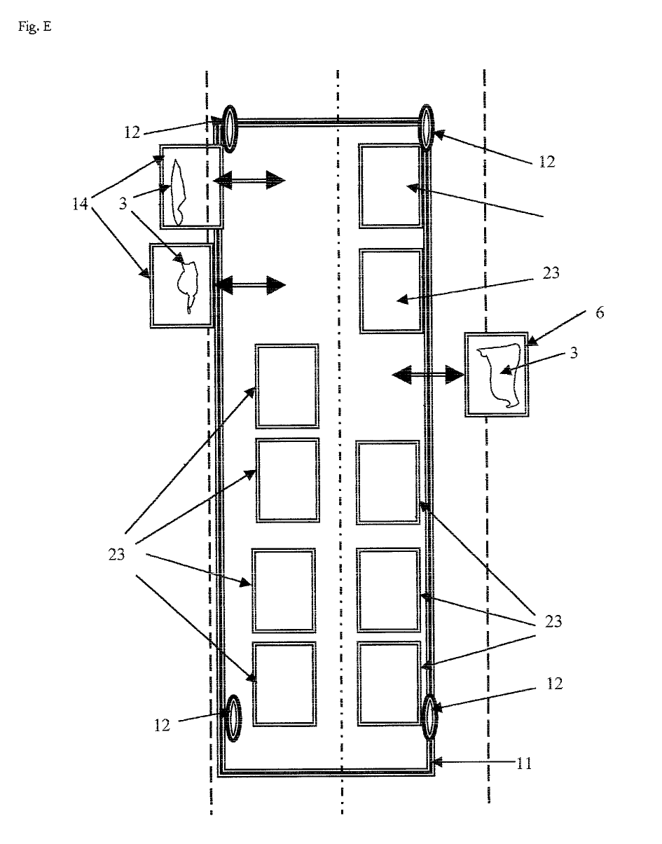

Figure four shows the top view of the lower level of the machine. The machine power system is located (7) at the front of the machine and the central computer (21) is located at the rear of the machine. The conduit area (22) connecting the central computer and control to the hoppers, tank and modules is indicated. This conduit area (22) also contains the various conveyer systems for moving the asphalt/concert material to the filling modules. The various repair modules 16, 17, 18, 20, 11, 19, 14, 15, 6, 13 are designated in the FIG. 4. The central computer (14) and engine (7) are located in the front and rear of the machine.

Fig E, The Machine Performing Repair Operations

Figure five shows the machine performing repair operations. The sawing modules (14) are sawing into the asphalt over two potholes (3) simultaneously. The asphalt-filling module (6) is filling the pothole (3) below its module. The modules have been moved outside of the main structure by robotic arms to perform these operations as indicated by the double arrows. Most repair modules are at their non-operational position (23) and not used at the time.

### DETAILED DESCRIPTION OF THE INVENTION

The Machine's Central Computer

The powerful central computer system will be purchased off the self (if possible) or designed specifically for the road repair machine by engineers and scientists as an instrument for performing the technical tasks and computational problem solving algorithms required by the road repair machine. The preference would be for a design based on existing, off-the-self hardware components, standard interfaces and peripherals, and combined with an advanced version of a multi-tasking operating system. The powerful central computer system must be able to support a variety of application programs concurrently running on auxiliary robotic repair module processors.

With this computer, the road repair machine will have dedicated compute power close to the modules required for the various road repair activities desired. Using the abilities of a multitasking operating system, this computer gives the machine the opportunity to run application programs on more than one repair module at a time.

The central computer will organize the jobs in a sequence so as to allow the machine to optimize the movement of the repair machine to reduce any unnecessary passage.

The computer needs to be able to run software programs effectively and efficiently. In meeting this need, system software becomes the key factor with respect to the central computer. From the machine's viewpoint, system software and interface hardware both need to be seamlessly distributed from the computer. Fortunately, the multi-tasking operating system makes this possible.

The multi-tasking operating system must have these features:

1—A stable, reliable and inexpensive operating system for running application programs.

2—A stable, reliable and inexpensive operating system for developing application programs.

3—Easily interfaces with the current and planned robotic module hardware designs with fast busses or wireless communication.

In addition, the multi-tasking operating system must accommodate software programs and tools to help with development of software applications. Included are the ‘C’, ‘C++’ Fortran, ADA and Pascal compilers, many library routines, and networking software to allow users to share resources and data. These are important in meeting all robotic module software needs used in conjunction with the central computer. The same type of central computer used in the road repair machine will be used to develop application programs off-line.

The main hardware needs for the central computer are: 64 or 128 bit processor, adequate memory and disk storage, standard network and communication interfaces, upgrade flexibility and to easily add new peripheral devices. Over time, as better hardware components become available, faster designs can be incorporated into new central computers—transparently, as the multi-tasking operating system will ‘hide’ these changes from users and their programs.

Existing application programs (either developed by the customer or purchased externally) must continue to operate when newer computer products are purchased to keep overall costs to customers as low as possible.

The multi-tasking operating system will become a de facto standard for many users based on its open and non-proprietary design. It's benefits include: many software tools and utilities, easy configuration for new hardware peripherals, virtual storage capability, and good networking ability. Use of industry standard I/O interfaces means customers will decide on their own solutions for external peripheral component needs.

Primary development plan goals for the central computer are:

Utilize multi-tasking operating system.

Flexible—open architecture means open options for users.

Use ‘off the shelf’ hardware—no special components or designs.

Using ‘off the shelf’ hardware to build a central computer has several key advantages: it minimizes the risk of any schedule impact due to design or part delivery problems, designs are more likely to support enhancements and upgrades over a long period of time, and lower prices from using mass produced components will improve product appeal to customers. Items in this category include: CPU and memory chips, power supplies, assembly components, etc.

Minimizing the use of proprietary hardware designs and interfaces helps to achieve faster design cycles and reduces the time required to place new products into the market. This greatly assists in maintaining upward compatibility of the user's hardware components. This greatly increases the market user-friendliness of the road repair machine.

Using the multi-tasking operating system maintains a stable user software programming interface. Multi-tasking software also provides a very adaptable and flexible capability for adding any new or improved hardware components with little or no impact to existing system programs. Software upward compatibility is preserved for customers.

In summary, the machine will be controlled by a powerful central computer, using existing off-the-self (if possible) hardware and multi-task software. The hardware will be as open as possible, allowing third party developers the opportunity to develop compatible hardware and increase the road repair machine's marketability.

Road Surface Analyzer

One of the most essential features of the road surface repair machine is the technology required to analyze the roadway, airport runway, parking lot surface, etc., to be repaired for defects, faults, flaws, etc. This technology will transform and evolve with time, and the modules containing the technology will be altered accordingly. As new technology is developed, these changes will be incorporated into the latest revisions of modules with-in the machine. As of now, the technology will be referred to as the radar/seismic detection system. This technology is available at this time

The radar/seismic detection system (used in the equipment in phase II & III), placed in one of the modules, will be capable of appraising all types of transportation structures/surfaces, including highway asphalt/concrete road surfaces (including bridges), airport runways, and parking lot surfaces. The purpose of these assessments is to support the determination of maintenance, preparation requirements and to provide the best possible reconstruction quality examination of the surface to be repaired.

The application of the assessment technology is customized to the requirements of the distinctive repair undertaking. The modular design of the robotic sub-systems allows this. Depending on the varying requirements, the radar/seismic detection module can be placed in a slot in the lower level of the road surface repair machine or be removed quickly and efficiently. One objective of radar/seismic detection phase of the repair is to optimize the quality of subsurface condition data collected over long-established methods of visual appraisal.

The radar/seismic detection system (module) will be capable of identifying the number and thickness of each layer in a multi-layer pavement arrangement. Data can be collected while the machine is moving up to 15 miles per hour. The module will determine the number of layers that are identifiable, provided the proportional dialectic constant of adjacent layers is different. For example, tow lifts of asphalt or older multiple overlays may not be discernible. The radar/seismic study will make available a uninterrupted outline of layer thickness, thereby determining consistency of the underlying foundation.

All air voids, possibly as small as 0.125 inch in thickness, can be recognized using the radar/seismic detection system. Identifying these areas and repairing them in a timely manner will avoid costly broken slab replacement. Enhanced quality control of grouting actions with pre and post-grout examination can be achieved. Radar/seismic subsurface examinations can be combined with other data to more precisely characterize individual project remedy necessities or all-purpose treatment approaches for repair of the roadway system.

The radar/seismic system must have several data acquisition modes, including continuous contour profiling and point stacking, put together the optimum data continuity throughout the entire contour of the roadway.

The radar/seismic system will be effective in identifying the moisture induced stripping of the asphalt cement from the combined surfaces which leaves an unbound aggregate mixture. With the detection of these areas, output of remaining life estimates and other computerized mechanistic models are improved. The decision to overlay or reconstruct may also be affected by the presence of stripping. Other repair efforts may be designed more cost effectively if the fill extent of the stripping is known.

The machine must be capable of determining the condition of concrete under an asphalt covered surface, the radar/seismic detection system must be able to analyze the debondment of the overlay under all circumstances. The machine must be able to establish the position of reinforced steel and establish the amount of moisture in concrete pavement. The machine will determine the location and quality of delaminated concrete, the depth of the reinforcing steel and the thickness of a bridge deck when analyzing road surfaces over bridges. In the cases of replacement of the reinforced steel, the radar/seismic module must ascertain the correct placement of the reinforced steel rods with-in cavities.

In addition to the radar/seismic technology within this module, the technology to provide an alignment laser beam emission system to direct a reference laser beam to provide leveling information will be contained within this module. Multiple optical beam splitters, mounted near the vicinity of each of the pavement sensors/reflectors will be aligned to capture the orientation laser beam emitted from the alignment laser beam emitter. These sensors/reflectors will be placed by the survey team during phase I.

The machine determines five circumstances:

1. Moisture in the base layer

2. Voids or loss of support under joints

3. Overlay delamination

4. Fine cracking

5. Pavement aging

In summary, it is crucial that the radar/seismic technology be able to provide an extraordinarily concise illustration of the roadway surface to be refurbished. The technology must be able to make a complete structural assessment of the region to be renovated.

The appraisal must authenticate liner thickness, existence of nonappearance of voids, rebar positions, malformed rock/soil configurations, foundation locations, reinforced steel locations.

With a comprehensive representation of the roadway to be repaired, the machine will be able to more successfully and efficiently repair the surface under evaluation.

Modular Design of Road Repair Robotic Units

An important feature of this invention is the modular design of the robotic repair units, each module will be of the same size (approximately 4 feet by 6 feet by 4 feet), which permits the placement of any repair module into any slot of the lower level of the machine. The central computer will recognize the location relationship of each module (with respect to positioning the module over the repair area) in the machine regardless of which slot in the lower level the module resides.

This aspect gives the machine flexibility regarding altering the placement of the repair modules in the machine based on the changes required because of different road surface repair needs. The modules will utilize technology that is already available, but, must be re-engineered to fit into the standard sized module slot in the lower level of the machine. An example is the radar/ seismic module, this technology exists, but, must be engineered, reduced, re-designed, etc., to fit into one of the module slots.

The repair modules will have ball rollers, or similar technology that allow the repair modules to be precisely positioned over the areas to be repaired. This feature allows the module to be moved in any x or y position unhindered and effortlessly.

Using these standard sized modules, machines with different numbers of modules can be built. Some machines will be built requiring 14 slots or modules, whereas some machines will not need that many modules and will be built with 6 or 8 slots or modules. A machine repairing asphalt roads may need only 6 modules.

The upper level hoppers will also utilize a modular design, accommodating two to four asphalt hoppers or a combination of multiple asphalt, concrete hoppers or debris holding hopper, this in case the road surface is a combination of asphalt/concrete material. The upper level will also have storage tanks (also modular) for liquid material, for such uses as applying a tack coat to vertical and horizontal surfaces required during certain phases of the repair operation.

The upper level will also contain water tanks used for the concrete saws, grinders and other equipment that require water for cleaning, cooling, etc. These upper level hoppers will have a delivery system, that is, conveyor belts (asphalt/cement), tubing (liquid material), allowing the transfer of asphalt/concrete or liquid material from the upper hopper level to the appropriate lower level modules. The upper level may also have a hopper to hold the debris material removed from cavities under repair.

Asphalt Hopper

A standard technique of repairing high quality surfaces for roads, airport runways, parking lots and other circumstances, is by means of the application of mixed paving materials such as bituminous slurry. The manufacture of bituminous slurry, as with virtually all paving materials, requires the mixture of several ingredients. The quality of the bituminous slurry or other road surface paving material is directly reliant on the comparative amounts of these components.

Present-day paving systems rely on calibration procedures to approximately estimate the amounts of the various ingredient parts of the paving material mixture. These calibration techniques do not provide response as to the quality, uniformity or formula of the paving material being produced as it is shaped.

Other present-day techniques allow for an operator of the machine to regulate the uniformity of the paving material combination at the job site based on visual inspection of the paving material as it is combined. These techniques require exceedingly skilled operators to be able to judge the suitable formula of the mixture and make the necessary regulation. In addition, the present method requires constant scrutinizing and may cause variability in the characteristic of the paving material.

One of the principal factors in the operation of the machines' asphalt hopper/asphalt delivery system is to provide the asphalt-filling module with a controlled application rate of material. Absent finishing an entire batch of road surface paving material, present-day techniques do not have any way of determining this “treatment swiftness”, which is usually measured as the weight of dry material used per unit area covered. Contemporary techniques weigh the amount of material at the beginning of the job and after the material has been used for the job, the over-all supply is measured to determine the amount of asphalt material used. This process doesn't allow delicate regulation as to the use of the repair material during the application of a batch of asphalt substance.

Regarding the present system of road surface repair, an operator is needed to facilitate the correct rate of application of the asphalt material by a visual rendering of the application process. The present technique provides no feedback with respect to the application of material for the duration of the process. My innovative machine will have sensing devices within the hopper, all along the asphalt delivery system, and within the asphalt-filling module, to provide feedback to the central computer regarding the amount of asphalt within the total system. The machines' delivery monitoring system constantly checks the uniformity and the application rate of the asphalt paving material during application of the asphalt.

The central computer constantly monitors the amount of asphalt material in the hopper, within the delivery system, and within the asphalt-filling module to determine when the asphalt hopper is in need of refilling. The central computer will estimate the amount of time until the refilling of the hopper is needed as to allow the trucks carrying the asphalt material ample time to arrive at the machine to refill the asphalt hopper. In the case of two very dissimilar asphalt materials required, the machine may be fitted with two hoppers, one of each type of material, again the flexibility of the modular structure of the machine allows this depending upon the road surface repair needs.

Repair Material Conveyor

The repair material conveyor system will have high response rate sensors along the conveyor delivery system to provide monitoring signals, as to the nature of the repair material (asphalt/cement), keeping the central computer informed as to the temperature and amount of material on the material conveyor. The temperature and amount of the material delivered can be changed within the limits of the heater/cooler and belt speed/capacity. Due to the rigorous system, the repair material (asphalt/concrete) will be delivered to the filling robotic modules with the correct temperature and the precise amount.

This ability indicates that such a feedback mechanism may be made to control a combination of factors of the material feed operation of the road repair machine, such as, the speed of the conveyor belt, control of the heating/cooling of the material, the amount of material released by the hoppers (asphalt/cement), etc.

Asphalt and Cement Filling Modules

The asphalt and cement filling modules will be able to determine the characteristics of the craters to be filled (based on information stored in the central computer from phase II), distinguish cavity measurements, and packing levels. During phase II, the analyst (civil engineers, material scientists) will determine what materials are needed for each cavity and program the central computer accordingly. With respect to road surfaces of a combination of concrete and asphalt, the machine will be equipped with both a concrete filling module and an asphalt-filling module.

The modules will control the dispensing of the asphalt/concrete material. The module will include a mounting device (over the cavity) to control the temperature of the asphalt or concrete filling material. The filler materials may be dispensed consecutively to provide dissimilar types of filler material (by the asphalt or cement filling modules) if necessary (stored in different hoppers on the second level). For cement filling, the cement is placed in the cavity, spread out within the cavity, leveled by the leveling module, and left to dry.

The machine will use quick drying concrete, allowing for the most time efficient repair process possible. The excess cement (after leveling) is left near the cavity to dry, and will be swept away later, either manually or with a more complex device, a sweeping module.

Regarding asphalt-filling requirements, after the module directs the material, that is, the material is placed in the cavity, the filling module robotic filling apparatus will be moved away from the cavity site. The radar/seismic module (the same module used during phase II) will contain a sensor to determine the amount of asphalt material in the cavity and how the material is placed in the cavity.

The modules (filling and radar/seismic) are switched until the proper amount of material is placed in the cavity and compacted to the optimized mass. Each time the filling module directs material into the cavity, it controls the position and dispensing plunger as well as the heating and flow of filler materiel within the cavity to be repaired, storing this information in the central computer to be used later. Another aspect related to this is using a very quickly setting asphalt repair patching material.

After the cavity is filled, the filling module will be shifted away from the cavity and the compacting or rolling module will be used to condense the material to the proper degree. To fully optimize the filling of the cavity, several operations amongst the filling module, radar/seismic module and the compacting/rolling module will be necessary before the cavity is properly filled.

Digging Robotic Module

The digging robotic module, a device similar to a backhoe, will be customized to fit within the module slot; this device will use existing technology. This robotic module will be able to remove the debris from the cavity in which the repair is to take place. The debris will be transported to a hopper, which will hold the material until it can be off loaded to a truck. This module will have sensing technology to determine if all of the debris material has been removed from the cavity, this information will be communicated to the central computer, indicating when the job is completed.

Drilling/Jackhammer

The drilling/jackhammer module will perform the operations required to drill & jackhammer the surface under repair.

Grinder Module

The grinder robotic module will be able to take rough spots out of concrete surfaces within a short time, ideal on all types of road surfaces, asphalt/concrete roads, bridges, sidewalks, and patios. This module will clean, level and smooth bumps and uneven areas, and remove paint spots, epoxies or any other type of material on the road surface.

This module will be very compact and easily adjustable for all types of cleaning, grinding and feathering. It will fit within a 4′×6′×4′ slot located in the lower level of the machine. This module will have sensing capability to establish if all of the surface material has been removed from the surface that is scheduled to be removed, this information will be communicated to the central computer, indicating when the job is completed.

Sawing Module

As indicated in another section of this patent, an important feature of this invention is the modular design of the repair robotic units; each module will be of the same size (4′ by 6′ by 4′). This permits the placement of any repair module in any section of the lower level of the machine. This aspect gives the machine flexibility regarding altering the placement of the repair modules in the machine based on the changes required because of different road surface repair requirements.

The sawing modules will have several types of asphalt/concrete sawing blades, an example, and a module for a certain requirement would contain a 14″ sawing blade and a 48″ sawing blade. Another sawing module may contain three blades, again, depending on the road surface repair requirements. All robotic sawing blades will include a shaft tachometer and a cutting depth indicator; in addition, the robotic arms will be able to be rotated for the blade to enter cut at up to a 20-degree angle.

Electric saws would be preferred to pneumatic saws. The electric saw would offer the ability to saw with no fumes, provide more power at the blade shaft, reduced blade RPM fluctuation, and vibration, and reduce sawing noise. With some applications, air compression saws would be preferred and the sawing modules could be customized to accommodate this type of saw.

I would prefer to use turbo blades that are designed to be smooth cutting with advanced high-density metal bond technology and high diamond concentration. This type of saw blade would provide for long life and smooth cutting in the widest range of materials, which would be necessary for roadbeds of a combination of concrete/asphalt and reinforced steel. The sawing module would have no problem sawing through concrete, metal, asphalt, masonry, stone, iron rods, etc. The robotic saw module would include an audible warning or prevent use condition if a blade is mounted incorrectly, which would protect it from damage or destruction.

The sawing module would include a water disc distributing system, which would make water available evenly to the blade, ensuring maximum cutting capacity and effective cooling. The blade drive unit would be easily accessible for servicing; the engagement and support rollers would be easily removable for trouble-free replacement.

Robotic Rolling Module

The machine's robotic rolling modules contain a weight deflectometer for examining the deflection of the pavement surface under repair. The deflectometer incorporates an alignment laser beam emitter that measures vertical displacement of each of a group of distance sensors mounted on a horizontal sensor bearer within the module that changes direction or vibrates as it is transported over a road surface for deflection measurement. This alignment laser beam emitter works in conjunction with the sensors placed by the survey team during phase I. This process allows measurement of the vertical displacements. The technology for this module is already in use for other road surface repair purposes and will be customized for use in the standard sized machine robotic modules.

The module makes available a rolling weight deflectometer, and measurement system for such a deflectometer, that compensates for inaccuracies in deflection. The modules will have several versions, some modules with smaller sized rollers, example: 6 inch, 12 inch, and 18 inch. Other roller robotic modules will have larger rollers, example: 12 inch, 24 inch, and 36 inch. Each roller module will have no more than three rollers. The magnitude of the road repair project will determine what sized rollers (modules) are inserted in the lower level slots of the machine. In some cases, the machine may contain two roller modules with different sized rollers.

In order to determine pavement condition for airport runways or highways, the load bearing capability of the pavement is occasionally tested. Load bearing capability may decline in due course, as a result of a number of reasons, including alteration in the elastic moduli of sub pavement layers of the sub-surface. Sub pavement earth layers subside or swell, their moduli are altered and affect the stability and load bearing capability of an overlying pavement.

With the intention of measuring the load bearing capability of the pavement, it follows that making use of technologies that are nondestructive must be used so as the reliability of the pavement layer is preserved. In addition, the measurements will be made as rapidly as possible, by means of the module, to lessen the repair period and further reduce expenses.

The module will provide a load on the rolling device, which rolls across the pavement and the depth of a deflection basin created by the loaded wheel is measured using precision laser sensors mounted on the module, plus, using the sensors placed by the survey team during phase I. Such deflection measurements provide insight into the load bearing capability of the pavement. The pavement deflections are usually very small, typically 0.010 to 0.040 inch for a 20,000 pound applied load. Because of this fact, very sensitive sensors are required to measure the deflection.

The module provides a rolling weight deflectometer, plus a manipulating system that automatically balances for sensor bearer member bending. This rolling module provides self-controlled member bending, for more precise measurements of pavement deflection under an applied load.

In summary, this robotic rolling module uses technology that already exists, that is, the system using the deflectometer, which incorporates an alignment laser beam emitter that measures vertical displacement. The uniqueness comes from the modular design of the robotic modules, which uses the existing technology, not from the technique using the deflectometer which capability already exists.

Crack & Joint Sealing Module

Most of the resources used in road surface construction have moisture susceptible rigidity. The rigidity of the surface diminishes as the moisture content of released granular materials and soils increases. Moisture leads to damage of asphalt concrete due to maturing, stripping, and adverse climate conditions. Water under Portland cement slabs can build up to very high pressures, wearing away the base and subbase materials. Crack and joint sealing aid to prevent such deterioration of the surface by reducing the infiltration of moisture from the surface into the pavement structure.

An engineer will normally use visual methods to review the obvious condition of cracks and joints to determine if crack and joint sealing is suitable. Most engineers will not seal a crack until it is greater than 5 mm wide. If the amount of deteriorating resultant from moisture at the joints and cracks could be determined, this information could help establish when crack and joint sealing is desirable to diminish the infiltration of moisture.

The engineer typically looks for signs of weathering, raveling and the occurrence of a composition of fine cracks that can be sealed with the surface seal. If the presence and level of aging could be determined, the damage to the asphalt because of aging could be stopped or diminished. If the dilapidation of paving materials because of nonstandard moisture levels in the asphalt and supporting layers or fine cracking could be determined, the requirement to position a blockade to reduce penetration of water into the structure could be appraised.

The crack/joint-sealing module will receive information from the analysis conducted in phase II, and stored in the central computer, to repair those cracks and joints determined necessary by the civil engineering and maintenance personnel. By doing so, the surface seals will extend the life of pavements by improving the surface roughness of the pavement, by reducing weathering, raveling, and decreasing the infiltration of moisture into the pavement structure.

### SUMMARY

In summing up, my invention is a machine that is capable of quickly and efficiently repairing many types of surfaces, from highways, airport runways, racetracks, to parking lot surfaces The machine is a highly modularized, very complex machine, which analyzes and repairs surface imperfections in those surfaces and sub-layers. The robotic facilitated road surface repair instrument completes these tasks while moving over the surface being renovated.

The objective of my invention is to provide a more resourceful, cost effective, and quicker method of repair with respect to asphalt and concrete surfaces to permit the transportation public a superior, more economical, safer means of travel. Later versions of this invention could some day be used to build highways, airport runways, racetracks etc.

1. Claim of the invention to provide a totally new procedure of three complex phases of the surveying, analyzing and repairing/renovation of a combination asphalt/concrete highway road surface, airport runway, race track, parking lot, etc.
Claim of the invention to first provide a means of surveying of the road and placing marking/positioning fixtures that will be used later during the later phases of the analysis of the surface for defects and actual road surface repair and renovation.
Claim of the invention is to use these marking/positioning fixtures placed during phase one to guide the invention and it's individual repair modules to the surface areas in need of repair.
Claim of the invention to use a modular radar/seismic detection system of existing technology placed in one of the standard sized module slots. This detection system will be capable of appraising all types of transportation surfaces, including highway asphalt/concrete road surfaces (including bridges), airport runways, and parking lot surfaces.
Claim of the invention is to use this analysis for the purpose of assessing the magnitude of maintenance required, the preparation requirements needed.
Claim of the invention is to input of the analysis data of the defects in the roadbed into the central computer to be used during phase three to repair of the roadbed, airport runway, parking lot, etc.
Claim of the invention is to provide a process to review the analysis data, gathered during phase two, by the decision makers, e.g., civil engineers, material scientists, etc., as to how severe the road surface defect's are.
Claim of the invention is to have the decision-maker's analyze/ diagram the proposed solution, after this analysis, the information is loaded into the central computer to be used during the actual repair.
Claim of the invention is for the decision makers to map out, that is, diagram, the regions in need of repair, input these diagrams, layouts into the central computer. The central computer will guide the repair machine and position it's modules to the areas in need of repair.
Claim of the invention is for the decision makers to determine: how deep to extract the openings, how wide to saw, what material to use, etc., with respect to every area/section of the surface needing repair.
Claim of the invention of using individual robotic repair modules, placed in equal sized slots, to automatically saw, fill, pack, level each of the sections of road surface in need of repair.
Claim of the invention of having all of the robotic repair functions fitting within the same size slots, some larger modules will require two slots. The modules can be moved to different slots within the machine depending of the nature of the repair needed.
Claim of the invention to have the complex, central computer keep track of the position of each repair module if it is moved to another slot within the machine.
Claim of the invention, which is much more intricate, complicated than existing road repair equipment and provides numerous multifaceted functions within one machine.
